(19) United States
(12) Patent Application Publication
(10) Pub. No.: US 2009/0008812 A1
(43) Pub. Date: Jan. 8, 2009

(54) METHOD AND APPARATUS FOR PRODUCING PLASTIC FILM

(75) Inventor: Kari Kirjavainen, Tampere (FI)

Correspondence Address: BROOKS KUSHMAN P.C., 1000 TOWN CENTER, TWENTY-SECOND FLOOR, SOUTHFIELD, MI, 48075, US

(73) Assignee: CONENOR OY, Tampere (FI)

(21) Appl. No.: 12/280,604

(22) PCT Filed: Feb. 22, 2007
(86) PCT No.: PCT/FI2007/050093

§ 371 Date: Aug. 25, 2008

(30) Foreign Application Priority Data
Feb. 24, 2006 (FI) 20065134
Jun. 5, 2006 (FI) 20065380

(51) Int. Cl. B29C 47/80

(52) U.S. Cl. 264/51; 425/72.1

(57) ABSTRACT

Plastic material and nucleating agent are fed into an extruder, and the plastic material is subjected to cell forming. The substances in question are extruded into a plastic film preform, simultaneously cooling the material to prevent foaming. The film preform is stretched in such a way that cavitation bubbles are generated in the film. The cell forming takes place in connection with stretching and relaxation. In other words, in the solution the cell forming is caused to take place when the plastic is not in a molten state.

### BACKGROUND OF THE INVENTION

The invention relates to a method for producing a plastic film, comprising feeding plastic material and nucleating agent into an extruder, subjecting the plastic material to cell forming by feeding into the plastic material in the extruder agent that generates gas or steam therein, extruding a plastic film preform with the extruder, and orientating the plastic film preform into a plastic film.

Further, the invention relates to an apparatus for producing a plastic film, comprising an extruder provided with a nozzle for extruding a plastic film preform, and at least one device that orientates the plastic film preform for orientating the plastic film preform into a plastic film.

U.S. Pat. No. 3,634,564 discloses a solution in which plastic material and foam-forming substance are fed into an extruder, and a foamed plastic film is extruded. The foamed plastic film is stretched in the longitudinal and cross direction to obtain a film containing fibres. The bubbles of the film obtained are, however, rather large.

Publication WO 99/51 419 discloses a solution in which a plastic film is extruded, some nucleating agent having been mixed into the plastic material of the plastic film. The film is orientated by stretching, whereby cavities are formed around the nucleating agent particles in the film. In connection with the orientating, gas is fed into the film, and this gas diffuses in the cavities formed. Publication WO 01/19 596 discloses a corresponding solution, in which gas is fed into the film after the first orientation. These solutions provide thin films with small bubbles. However, with these solutions it is rather challenging to provide films with a high foaming degree.

### BRIEF DESCRIPTION OF THE INVENTION

An object of this invention is to provide a new type of method and apparatus for producing a plastic film.

The method according to the invention is characterized by cooling the material while extruding it from the extruder to prevent foaming of the material, and causing cell forming of the material only in connection with the orientation and/or relaxation.

The apparatus according to the invention is characterized in that the apparatus comprises a cooling means arranged at the final end of the extruder, the cooling means being arranged to cool the material being extruded to prevent cell forming of the material.

In the solution presented, plastic material and nucleating agent are fed into an extruder, and the plastic material is subjected to cell forming. The plastic material is subjected to cell forming by feeding into the plastic material in the extruder for example chemical foaming agent and/or gas and/or liquid causing cell forming, which material tends to cause gas or steam generation in the plastic material. These substances are extruded into a plastic film preform, simultaneously cooling the material to prevent foaming. In a prior art device, the plastic material would get foamed when exiting the extruder, and typically, it would subsequently be conveyed to cooling. In the present case, the material does not get foamed in the extruder due to the pressure in it, and not even when exiting the extruder, because the plastic material is cooled as early as when it is being extruded, i.e. not only in the cooling device after the extruder. The film preform is stretched in such a way that cavitation bubbles are generated in the film, and gas gets into these bubbles, in other words the cell forming takes place in connection with stretching, or then the cell forming is arranged to take place in connection with the relaxation stage or relaxation stages. In the solution cell forming is, in other words, caused to take place when the plastic is not in a molten state. Cell forming means flowing of the gas/steam dissolved in the plastic into the cavitation cells, and their expansion particularly in the perpendicular direction of the product. So, this is not conventional foaming, in which the plastic material gets foamed when exiting the extrusion nozzle, but here the expansion of the cells does not take place until in connection with the orientation and/or relaxation. Such a solution provides a film having a small cell structure and low density. Therefore, a light and thin micro-celled film can be obtained. All in all, the solution is simple. When there is cooling in connection with the extrusion nozzle, it is not necessary to have other cooling devices in the production line system.

### BRIEF DESCRIPTION OF THE FIGURES

The invention will be explained in more detail in the attached drawings, in which

FIG. 1 shows schematically a side view and cross-section of an apparatus for producing a plastic film;

FIG. 2 shows a top view and cross-section of the apparatus of FIG. 1;

FIG. 3a shows schematically a side view and cross-section of a plastic film produced with the apparatus before the orientation of the film;

FIG. 3b shows schematically a side view and cross-section of a plastic film produced with the apparatus after longitudinal orientation;

FIG. 3c shows schematically a top view of the plastic film of FIG. 3b;

FIG. 3d shows schematically a top view of a plastic film produced with the apparatus after longitudinal and transverse orientations; and

FIG. 3e shows schematically a side view and cross-section of the plastic film of FIG. 3d;

FIG. 4 shows schematically a side view and cross-section of the nozzles and drawing device of a second apparatus;

FIG. 5 shows schematically a side view and cross-section of the nozzle and belt roll system of a third apparatus;

FIG. 6 shows schematically a side view of a relaxation unit; and

FIGS. 7a and 7b illustrate schematically the effect of the relaxation on the shape of a bubble.

For the sake of clarity, the figures show some embodiments of the invention in a simplified manner. Similar parts are denoted with the same reference numerals in the figures.

### DETAILED DESCRIPTION OF SOME EMBODIMENTS OF THE INVENTION

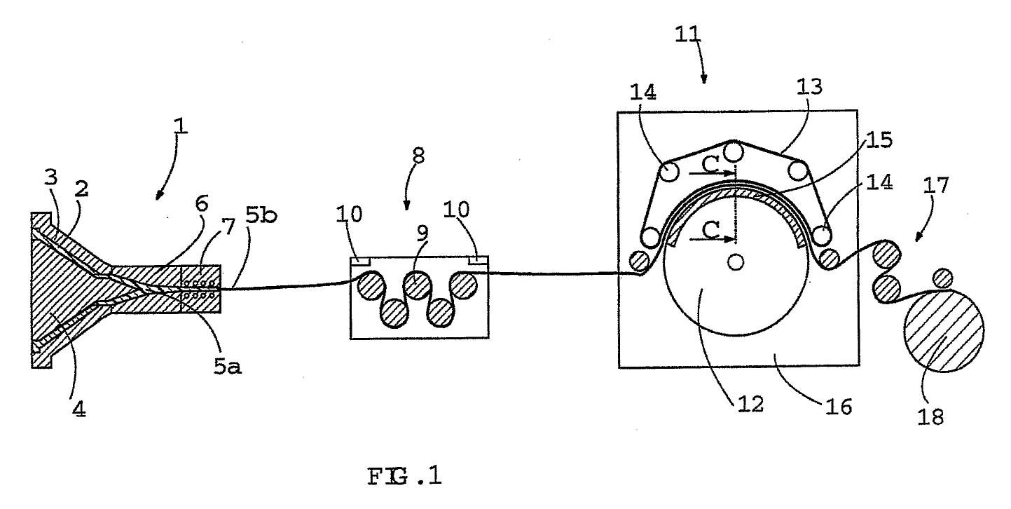

FIG. 1 shows a side view of an apparatus for producing a plastic film. The apparatus comprises an extruder 1. The extruder 1 may be, for example, conical in such a way that it has a conical rotor 2, in the outside of which an outer stator 3 is arranged which is conical at least on its surface on the side of the rotor 2, and in the inside of which an inner stator 4 is arranged which is conical at least on its surface on the side of the rotor 2. When rotating, the rotor 2 presses the material between the rotor 2 and the stators 3 and 4 out of the extruder 1 in a manner known per se. For the sake of clarity, the rotation devices of the rotor or the feed devices for feeding the material to be extruded into the extruder 1 are not shown in the attached figures. The extruder 1 may also comprise more than one rotor 2 and more than two stators 3 and 4. In such a case, multilayer products can be extruded with the extruder 1. The solution of one rotor and two stators 3 and 4 allows making two-layer products.

The extruder 1 may also be any conventional cylindrical one-screw or two-screw extruder or any other extruder applicable to extruding plastic films.

The final end of the extruder 1 comprises an extrusion nozzle 6 and a cooled extension nozzle 7 arranged in connection with it. The nozzles 6 and 7 form a relatively shallow and wide opening, through which the plastic 5a is extruded in such a way that a plastic film preform 5b is generated. The width of the nozzle 6 and 7 may vary between 400 and 2 000 mm, for instance. The thickness of the plastic film preform extruded may vary between 0.1 mm and 1 mm, for instance.

From the nozzle 7, the plastic film preform 5b is supplied to a machine-direction orientation device 8. The machine-direction orientation device comprises orientation rolls 9, the velocities of which are adjusted in such a way that by means of the rolls the plastic film preform 5b is stretched and then orientated in the machine direction. If desired, the velocity of each orientation roll 9 can be adjusted separately. The machine-direction orientation device 8 may also comprise heating means 10, such as radiation heaters, for heating the plastic film preform 5b in a manner known per se. The plastic film preform 5b can also be heated by means of orientation rolls 9 in such a way that heating medium, such as heated oil, is supplied to the orientation rolls 9 in such a way that the orientation rolls 9 get warm. If desired, the temperature of each orientation roll 9 can be adjusted separately.

After the machine-direction orientation device 8, the plastic film is supplied to a cross-direction orientation device 11. In the cross-direction orientation device 11, the plastic film preform 5b is stretched in the cross direction, in other words the orientation takes place substantially perpendicularly to the orientation in the machine-direction orientation device 8. The structure of the cross-direction orientation device 11 is such, for example, that it has two orientation wheels 12, an orientation band 13 being arranged against both of them. The orientation band 13 is an endless band, and it is guided with band guide rolls 14. The edges of the plastic film preform 5b are arranged between the orientation wheel 12 and the orientation band 13. Thus, the edges of the plastic film preform 5b are pressed between the orientation band 13 and the orientation wheel 12 evenly substantially along the whole travel of the cross-direction orientation device 11, and intensely at the orientation band 13, whereby the film preform is not subjected to point-like pressure stress or tensile stress, and thus the film preform stretches sideways without tearing. In FIG. 1, the plastic film preform 5b and the orientation wheel 12 as well as the orientation band 13 are illustrated, for clarity, as being at a distance from one another, but in reality these parts are firmly pressed against each other. The orientation wheels 12 and, correspondingly, the orientation bands 13 are arranged in such a way that in the direction of travel of the plastic film preform 5b they are further away from each other at the final than at the start end, as illustrated in FIG. 2, whereby the cross-direction orientation device 11 stretches and, at the same time, orientates the plastic film preform 5b in the cross direction. The deviation of the angle between the orientation wheels 12 and the orientation bands 13 in the machine direction can be adjusted to regulate the desired degree of the cross-direction stretching. One or more guide rolls 14 can be arranged to be rotated by means of rotating means. Since the bands 13 are firmly pressed against the orientation wheels 12, the orientation wheels 12 do not necessarily need rotating devices but may rotate freely. For the sake of clarity, the attached figures do not show rotation devices or other actuators of the device. A curved support plate 15, which has substantially the same shape as the circumference of the orientation wheels 12, is arranged between the orientation wheels 12 to support the plastic film preform 5b.

The cross-direction orientation device 11 can be arranged in casing 16 of its own. If desired, the casing 16 can be provided with heaters known per se, such as radiation heaters, to heat the plastic film preform 5b.

The cross-direction orientation device may also be a conventional cross-direction orientation device provided with several rotating pinchers that are separate or attached to each other. Further, the orientation can be implemented with a device in which the longitudinal and the cross direction stretching take place simultaneously or by using another device applicable to the orientation of plastic films.

The process can also be implemented as what is called Double Bubble type. In this case, a tubular preform is extruded and simultaneously cooled, and this tubular preform is orientated by blowing and stretching.

The plastic film 5 obtained after the cross-direction orientation device 11 is supplied to a relaxation unit 17. In the relaxation unit 17 the plastic film 5 is relaxed, whereby the plastic film shrinks slightly. Finally, the plastic film 5 is wound on a reel 18.

In FIG. 2, the apparatus according to the invention is shown from above and, at the point of the extruder 1, as a cross-section. For the sake of clarity, FIG. 2 does not show the plastic film preform or the plastic film, nor the support structures of the apparatus to which the rolls and reels as well as the plates of the apparatus are attached.

Before the extrusion, foaming agent and nucleating agent are mixed into the plastic 5a. The foaming agent may be, for example, azodicarbonamide or some other chemical foaming agent, or for example gas, such as carbon dioxide or liquid. The nucleating agent causes the joint surface of the plastic molecules to tear when the plastic film preform is stretched, so that at the tearing points cavities, i.e. cavitation bubbles, are generated, in which gas or vaporizing liquid diffuses at the orientation temperature. The nucleating agent may be, for instance, calcium carbonate particles or some oily substance, such as silicone oil or paraffin oil. Further, the nucleating agent may be plastic with no adhesion to the plastic that forms the plastic film. If the nucleating agent is plastic, its melting point is typically higher than the melting point of the plastic forming the plastic film. For example, polyester may be mixed into polypropylene PP to serve as the nucleating agent.

The materials to be extruded, i.e. plastic, foaming agent and nucleating agent, can be fed into the extruder either freely as separate materials or as completely or partly precompounded material. A chemical foaming agent, for instance, can be mixed into plastic granulates, and a foaming liquid or gas, for instance, can be pumped into the extruder at the extrusion stage.

The material mixture in the extruder 1 is at such a high pressure that cell forming does not start yet. If carbon dioxide, for instance, is used for the cell forming, its pressure in the extruder 1 is in the range of 100 bar. In the extruder 1 the gas is dissolved in plastic, in other words the gas is between plastic molecules.

In the cooled extension nozzle 7, the material is cooled to such a low temperature that cell forming does not start when the plastic exits the extruder. Typically, the plastic is cooled below its crystallization point.

When the plastic film preform 5b is stretched, cavities are generated on the joint surfaces of the nucleating agent and plastic molecules. Thus, the cell forming of the plastic preform starts as the gas moves, for the most part, into the cavities.

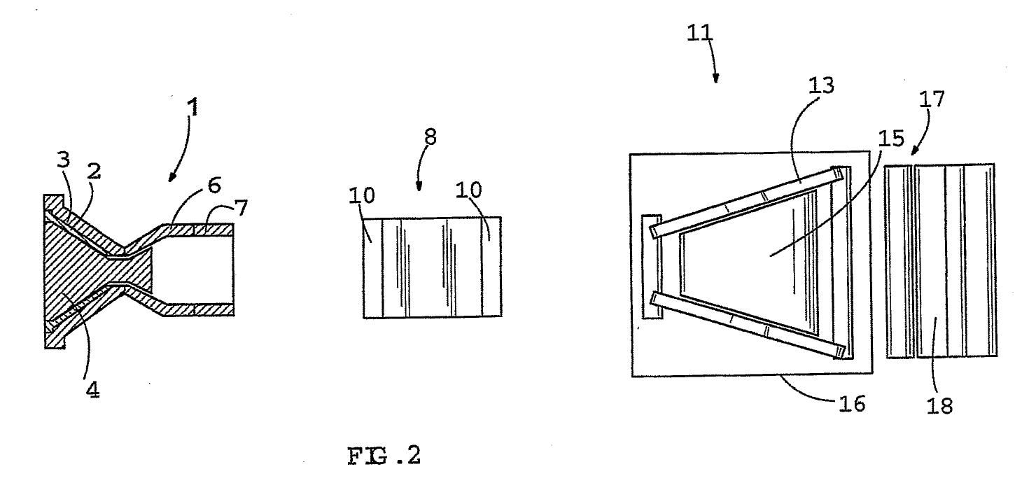

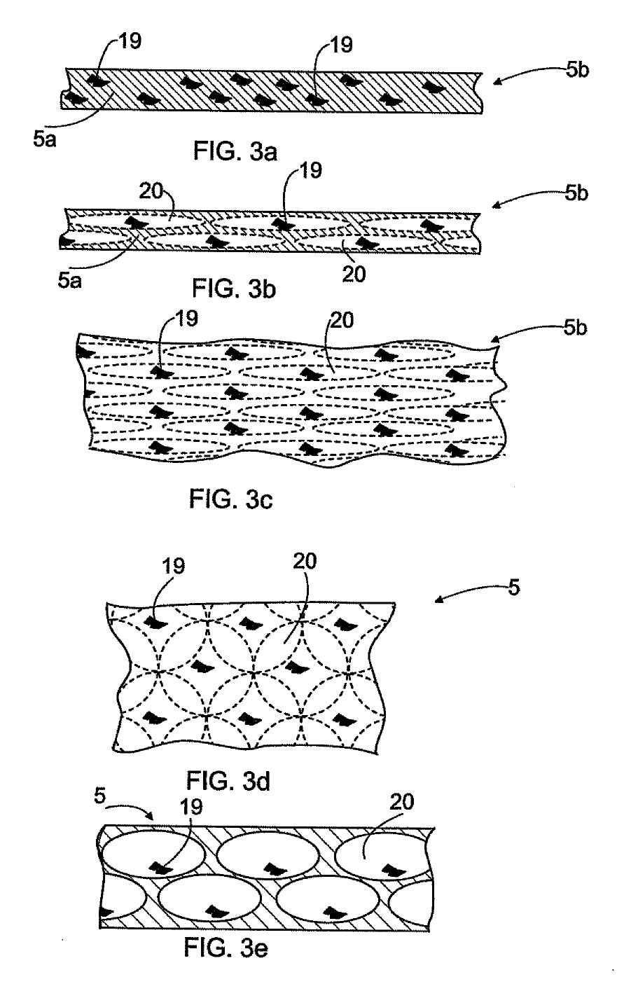

FIG. 3a shows calcium carbonate particles 19 mixed into the plastic 5a. FIGS. 3b and 3c show a plastic film preform 5b after it has been stretched in the machine-direction orientation device 8. Thus, bubbles 20 containing gas have been generated in the plastic film preform 5b. The pressure of the gas inside the bubbles is lower than in the extruder. Typically, at this stage the pressure of the gas may be in the range of 50 bar.

Next, the plastic film preform 5b has been stretched with a cross-direction orientation device 11. FIG. 3d shows the plastic film after the cross-direction stretching. In the cross-direction orientation device 11, the bubbles 20 have been widened by the orientation and widened and expanded by the gas released. In other words, now the bubbles 20 may also be wide. Further, the bubbles 20 may be flat, in other words they may be of a plate or disc shape. The bubbles 20 are rather small, their diameter being in the range of 10 to 100 μm. The height of the bubbles 20, in turn, is typically below a few micrometers, for example about 10 μm. The gas may also expand the bubbles 20 in such a way that their height may be in the range of 50 to 100 μm, for instance. Very thin plastic films can be obtained with the solution presented. The thickness of the plastic film may be, for example, 30 μm to 3 mm, depending on the orientation ratio and the amount of foaming agent. The density of the plastic film 5 may be 0.5 to 0.05 g/cm³, for example. Both the machine-direction orientation ratio and the cross-direction orientation ratio may vary between 2 and 12, for instance.

In the cross-direction orientation, the height of the bubbles 20 increases, in other words the plastic film 5 gets thicker. The pressure of the gas in the bubbles 20 decreases, being at this stage typically about 2 bar. The plastic film 5 is, at this stage, biaxially orientated and expanded, as shown in FIG. 3e.

Different products can be obtained with different orientation manners. Orientating the plastic film preform 5b only in the machine direction provides a plastic film orientated in the machine direction. Performing the orientation first in the machine direction and then in the cross direction in the way shown in FIGS. 1 and 2 provides a plastic film orientated biaxially, as mentioned. A different plastic film is obtained by orientating the plastic film first in the cross direction and after that in the longitudinal direction, although even in this case it is a plastic film orientated biaxially. Yet a fourth different plastic film can be obtained by orientating the plastic film preform 5b only in the cross direction.

If desired, the nozzles 6 and 7 can be coated with, for example, polytetrafluoroethylene PTFE to reduce friction. On the other hand, slip agent can be supplied between the cooling nozzle 7 and the plastic 5a to be extruded by utilizing capillary joints known per se to reduce friction. Cooling of the nozzle 7 can be implemented with oil circulating tubes, for example.

Also a multilayer plastic film preform 5b can be extruded with the extruder 1 or with several extruders attached to the nozzle 6, 7. In such a case, skin layers with poor gas permeability can be arranged on the surface of the plastic film, whereby the gas can be made stay on the basic layer of the plastic film extremely well. The plastic film provided can thus be formed of only one material layer that has undergone cell forming, or then the final product may comprise a multilayer film structure in which one or more layers having undergone cell forming are part of the rest of the film structure.

Nucleation of cells may also be started inside the nozzle of the extruder 1 by drawing the cooled plastic film preform 5b with a drawing device 21 at a velocity slightly higher than the extrusion velocity. In the solution of FIG. 4, the drawing device is integrated with the cooling nozzle 7. By using the drawing device 21 only a few nucleating particles are needed for nucleating the cavities. There may be for example approximately 2% of calcium carbonate particles in the material.

Stretching may be made so great that the cells stretch in the longitudinal direction inside the nozzle, and machine-direction orientation is generated in the plastic film preform 5b. Thus, gas is released into machine-direction cavities generated, and thus another orientation device is not necessarily needed.

Further, the product can be orientated in the cross direction, whereby the whole of the gas in the product is released into cells, expanding them also in the perpendicular direction. Thus, an extremely light and thin micro-celled product is provided.

When the drawing device 21 is arranged immediately after the cooling nozzle 7 in accordance with FIG. 4, the flowing rate can be stabilized in the nozzle. The drawing device 21 also compensates for the friction caused by the nozzle and its variation and decreases the nozzle pressure. The drawing device 21 allows accurate adjustment of the desired pressure drop and the nucleation of the material in the nozzle. The drawing rolls of the drawing device 21 may also be cooled.

The nozzle may be formed of different zones also in such a way that after the cooling zone the nozzle has an orientation zone, in which the plastic film preform is heated into the orientation temperature. Thus, in the cooling zone the plastic is first cooled into a temperature colder than the crystallization temperature, and in the orientation zone the plastic film preform is heated and machine-direction orientation is formed in it by means of the drawing device 21.

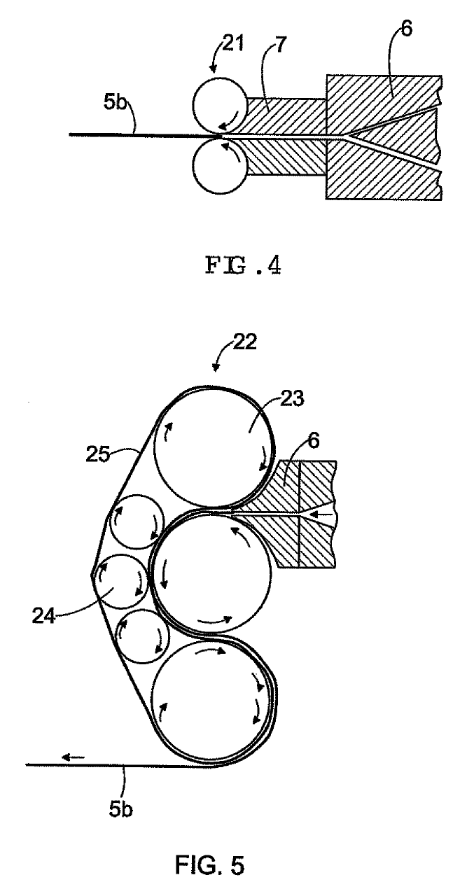

FIG. 5 shows a solution in which the plastic film preform 5b is cooled with a wide, cooled belt roll system 22 integrated with the nozzle 6. The belt roll system 22 comprises cooled rolls 23, auxiliary rolls 24 and an endless band 25. The band 25 may be manufactured of steel, for example. The diameter of the cooled rolls 23 may be, for instance, in the range of 150 to 200 mm.

Such a solution is advantageous at high production rates because the nozzle part 6 can be kept short. There may also be a cooling nozzle 7 in connection with the nozzle 6. The belt roll system 22 may also draw the product out of the nozzle, causing nucleating and orientation.

In the extruder, also some liquid may be pumped into the plastic to serve as cell-forming agent, either solely or in addition to cell-forming gas. The liquid is thus a suitable liquid substance at room temperature, and correspondingly, the cell-forming gas is a suitable gaseous substance at room temperature. The liquid may be for instance water functioning thus as propellant at the orientation stage. The water is vaporized at the orientation temperature, which imposes increased pressure on the cell growth. If there is both gas and water in the material, the vaporized water is condensed back to liquid but the gas remains in the cavities, which do not return to a smaller size.

It is easy to adjust the density of the plastic film manufactured with the presented solution, for example by adjusting the amount of gas and/or liquid to be supplied and/or the orientation ratios.

More preferably, however, the plastic film 5 and the plastic film preform 5b are supported and tempered during the orientations in such a way that the plastic film preform 5b does not undergo cell formation until in the relaxation unit 17. When the material is not subjected to cell formation until in the relaxation unit 17, the longitudinal and transverse forces directed at the film can be minimized. Relaxation can also be performed at the final end of the orientation device.

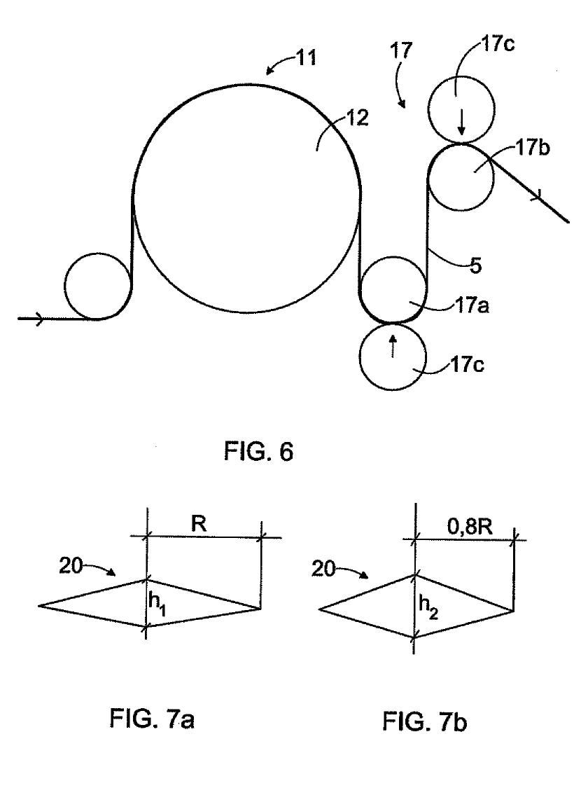

FIG. 6 shows a relaxation unit 17. The relaxation unit 17 comprises a first relaxation roll 17a, a second relaxation roll 17b and support rolls 17c. It is preferable to relax the plastic film 5 after the cross-direction orientation device 11 in both the longitudinal and cross direction rather a lot, for example more than 10% or even more than 20%. If bubbles 20 have already been generated, their walls shorten in both directions, and when the amount of gas or air in the bubbles 20 remains constant, the height of the bubbles 20 increases. This improves the compression strength and bending stiffness of the film 5 essentially because it has been possible to make the bubbles 20, which were very flat before, more symmetrical.

Relaxation takes place by heating the film 5 close to the melting point on the first relaxation roll 17a. The film 5 can shrink in the cross direction in the free draw between the first relaxation roll 17a and the second relaxation roll 17b. In the longitudinal direction, the shrinkage is adjusted by adjusting the difference between the circumferential velocity ω₁ of the first relaxation roll 17a and the circumferential velocity ω₂ of the second relaxation roll 17b. On the second relaxation roll 17b, the plastic film 5 is cooled.

The relaxation apparatus may also be a roll system comprising more than two rolls, for example ten rolls or even more. In such a case, the temperatures of the rolls are selected in such a way that the temperature rises in the direction of the track, and the velocity differences of successive rolls are reduced by degrees.

When the material of the plastic film is not subjected to cell formation until in connection with relaxation, for example between the first relaxation roll 17a and the second relaxation roll 17b, whereby neither cross-direction nor longitudinal drawing is directed at the plastic film 5, the bubbles 20 are capable of contracting in the longitudinal and cross direction.

FIGS. 7a and 7c illustrate the effect of the relaxation on the shape of the bubbles 20. FIG. 7a shows the bubble 20 in a situation where the film has not been essentially relaxed. In FIG. 7b, in turn, the film has been relaxed 20% in both the longitudinal and cross direction. In the non-relaxed film the radius of the round bubble 20 is R, and correspondingly, in the relaxed film the radius of the bubble 20 is 0.8 R. In the non-relaxed film the height of the bubble 20 is h₁. In the relaxed film the height of the bubble 20 is h₂. The volume of the bubble 20 of the non-relaxed film is

V₁=k·h₁·π·R²,

and correspondingly, the volume of the bubble 20 of the relaxed film is

V₂=k·h₂·π·(0.8R)²,

where k is a shape constant.

Since the amount of gas or air inside the bubble 20 remains constant, the volume of the bubble 20 remains constant, i.e.

V₁=V₂

i.e.

k·h₁·π·R²=k·h₂·π·0.64·R²,

which gives

h₁=h₂·0.64,

which, for its part, gives

h₂=1.5625·h₁.

Thus, the height of the bubble 20 increases approximately 56% when the plastic film is relaxed 20% both in the longitudinal direction and the cross direction. As the height of the bubbles 20 increases, the thickness of the film 5 increases correspondingly. The shape constant k may be assumed to be constant, because the shape of the bubbles 20 does not change essentially. For the sake of clarity, in respect of their width the bubbles 20 in FIGS. 7a and 7b are shown higher than in reality.

The plastic film may be relaxed to different extents and in different directions, for example more in the cross direction than in the longitudinal direction. Further, the plastic film may be relaxed either merely in the longitudinal direction or merely in the cross direction. Thus, a desired increase in the height of the bubbles can also be achieved with relaxations in one direction only.

Preferably, therefore, the plastic film is relaxed to rather a great extent. The extent of relaxation can be determined in such a way, for instance, that the added extent of cross-direction and longitudinal relaxation is preferably more than 20%, and especially preferably the added extent of the cross-direction relaxation and longitudinal relaxation is more than 40%. Typically, the relaxation in the cross direction is easier, so that preferably the plastic film is relaxed more in the cross direction than in the longitudinal direction. Thus, relaxation in the longitudinal direction may even be 0%.

The plastic film 5 manufactured may be used as, for example, a packing film, a label film, a peelable film or synthetic paper, or for another suitable object of use. If the film is relatively thick, it can be used as a deep-drawable sheet, for instance. By providing the film with permanent electric charge the film can be utilized in electromechanical applications. The film can be formed of, for example, polypropylene PP, high density polyethylene HDPE, linear low density polyethylene LLDPE, cyclo olefin copolymer COC, polyethylene terephthalate PET, polyamide PA, polystyrene PS, polyvinyl chloride PVC or other biodegradable plastic, such as polylactose PLA.

In some cases, the features described in this application can be used as such, irrespective of other features. On the other hand, features described in this application can, if required, be combined to obtain different combinations.

The drawings and the related description are only intended to illustrate the idea of the invention. The details of the invention can vary within the scope of the claims. The relaxation unit, for example, may be a separate apparatus and treatment process in which an already reeled orientated film can be treated in the above-described manner.

1. A method for producing a plastic film, comprising feeding plastic material and nucleating agent into an extruder, subjecting the plastic material to cell forming by feeding into the plastic material in the extruder agent that generates gas or steam therein, extruding a plastic film preform with the extruder, and orientating the plastic film preform into a plastic film, characterized by
cooling the material while extruding it from the extruder to prevent foaming of the material, and causing cell forming of the material only in connection with the orientation and/or relaxation.

2. A method according to claim 1, characterized by
stretching the plastic film preform in a nozzle of the extruder to obtain cavitation nuclei.

3. A method according to claim 2, characterized by
stretching the plastic film preform with a drawing device positioned in connection with the nozzle.

4. A method according to claim 1, characterized by
stretching the plastic film preform with a separate orientation device.

5. A method according to claim 1, characterized by
stretching the plastic film preform in two different directions.

6. A method according to claim 4, characterized by
stretching the plastic film preform first in the longitudinal direction and subsequently in the cross direction.

7. A method according to claim 4, characterized by
stretching the plastic film preform first in the cross direction and subsequently in the longitudinal direction.

8. A method according to claim 1, characterized by
subjecting the plastic material to cell forming by feeding gas and/or liquid into the extruder.

9. A method according to claim 1, characterized by
causing the cell forming of the material only in connection with relaxation.

10. An apparatus for producing a plastic film, comprising an extruder provided with a nozzle for extruding a plastic film preform, at least one device that orientates the plastic film preform for orientating the plastic film preform into aplastic film, and a relaxation unit for relaxing the plastic film, characterized in that
the apparatus comprises a cooling means arranged at the final end of the extruder, the cooling means being arranged to cool the material being extruded to prevent cell forming of the material.

11. An apparatus according to claim 10, characterized in that
a drawing device is arranged in connection with the nozzle to orientate the plastic film preform.

12. An apparatus according to claim 10, characterized in that
the apparatus comprises at least one orientation device separate from the extruder.

13. An apparatus according to claim 12, characterized in that
the orientation device is such that longitudinal stretching and cross-direction stretching are implemented simultaneously.

14. An apparatus according to claim 12, characterized in that
the apparatus comprises a machine-direction orientation device and across-direction orientation device.

15. An apparatus according to claim 10, characterized in that the cooling means is a cooled nozzle.

16. An apparatus according to claim 10, characterized in that the cooling means is a belt roll system.
